(19) United States
(12) Patent Application Publication
(10) Pub. No.: US 2012/0137302 A1
(43) Pub. Date: May 31, 2012

(54) PRIORITY INFORMATION GENERATING UNIT AND INFORMATION PROCESSING APPARATUS

(75) Inventor: Yasuhiro Tsuchida, Osaka (JP)

(73) Assignee: PANASONIC CORPORATION, Osaka (JP)

(21) Appl. No.: 13/389,365

(22) PCT Filed: Mar. 8, 2011
(86) PCT No.: PCT/JP2011/001357

§ 371 Date: Feb. 7, 2012

(30) Foreign Application Priority Data
Jun. 18, 2010 (JP) 2010-139502

(51) Int. Cl. G06F 9/46

(52) U.S. Cl. 718/103

(57) ABSTRACT

In an information processing device 1 for running a multitask application, an priority information generating unit 104 generates priority information, in accordance with source information and processing performance with respect to each task (i.e. a time required for processing the task and a frame rate at which the task is processed) to be run in the information processing device 1. The source information indicates frequencies of event occurrence as the measure of likelihood that, when an input has been received in an input unit 12 of a content task currently running, another input following the input is to be received. The generated priority information indicates timings for changing the priorities upon reception by the input unit 12 and indicates priorities to be set at the timings. In accordance with the generated priority information, the priority control device 10 performs control of changing the priorities of the content tasks.

### TECHNICAL FIELD

The present invention relates to an information processing device for running a multitask application, and in particular relates to control for changing priorities of a plurality of tasks.

### BACKGROUND ART

Conventionally, in mobile information terminals such as a mobile phone, having a single application occupy the entire screen has been the mainstream as a way of running an application, due to restrictions on resources such as CPU (Center Processing Unit) and memory installed in the terminals.

However, owing to a recent development in performance of mobile information terminals, a combined content, which realizes a single application screen while combining respective contents rendered by a plurality of content engines operating in parallel, is appearing.

A typical example of such a combined content is a web page. On a recent web page, a plurality of tasks are operated, and respective images generated by the tasks are combined for display. Examples of such tasks include a rendering engine for a main item on the page, a rendering engine for affiliate FLASH movie that is to be displayed in the web page, and a rendering engine for advertising animation.

In order to realize such a combined content, it is necessary to assign a task (thread, slice) to each content task of content engines for processing, and make the set of tasks run in parallel using a task scheduler in an OS (Operating System). Since a general mobile information terminal is installed with a single CPU (or CPUs which are less in number than tasks), the task scheduler assigns the tasks with respective processing times in a time-sharing manner. This type of multitask system is also called time-sharing system.

A variety of methods have been proposed for assigning the processing times to the tasks in the time-sharing. For example, in Linux™, which is employed as the OS in a variety of mobile information terminals, the task scheduler assigns each task i with a time slice Ti and performs control so that the task assigned with the largest Ti is run. Then, a value of Ti is reduced by the length of processing time for which the task used the CPU. Consequently, task switching occurs.

When the values of Ti for all the executable tasks have reached 0, new values Ti are reassigned to the tasks in accordance with the following (Equation 1).

$$\begin{matrix}[ Math 1 ] & \\ {T}_{i} = \frac{{T}_{i}}{2} + {Q}_{i} & ( Equation 1 )\end{matrix}$$

Note that in the above Equation, a value obtained by dividing Ti by 2 is added. The reason is to raise a priority of a task (e.g. a task waiting for I/O (Input or Output)) other than the executable tasks (note that any value of Ti is greater than or equal to 0, and the above value is added to a new Ti).

Furthermore, Qi in (Equation 1) is a variable called time quantum. As the time quantum of a task becomes larger, the value assigned as the new Ti becomes larger, whereby the task is processed with a higher priority than other tasks. The time quantum value is resettable with use of a system call nice ( ). On the other hand, the time slices can be referenced and updated only by the time scheduler. With the above structure, the multitask application is able to set the value (i.e. argument of nice( ) used for specifying a processing priority of a task through calling of nice( ). The value specified in this way is called a task priority. Furthermore, with the task scheduler specifying the tasks to be processed by the time slicing method, the multitask application is able to prevent a specific task from occupying the entire processing.

In a multitask application which includes a plurality of tasks combined as a single application, responsiveness to user operations can be improved by resetting the argument of the system call nice( ) that is to say, by dynamically changing the priority of a specific task, depending on an application's running state (See Patent Literature 1, for example).

### CITATION LIST

### Patent Literature

[Patent Literature 1] Japanese patent application publication No. 2007-265330

### SUMMARY OF INVENTION

### Technical Problem

However, as mentioned above, reassignment of the time slices based on the time quantums, in other words, priority setting using the system call nice( ) cannot be executed until the time slices of all the executable tasks reach 0 in the above Patent Literature 1. Accordingly, even if a large time quantum is reassigned to a task for which a user operation has been made, the task switching in accordance with the reassigned time quantum is performed after a slight delay. For example, assume a case where a default time quantum (100 msec) is set to each task. In this case, the delay of approximately a 100× the number of tasks (msec) is caused at worst (where the time slice of the operated task is 0 msec, and the time slices of other tasks are each 100 msec). The above delay is not acceptable, since, for realization of smooth user operation, it is required to exhibit sufficient responsiveness to display what is supposed to be displayed within 100 msec after a user operation.

To address the above problem, it is necessary to create a situation where a time slice value of an operated task is larger than time slice values of other tasks at each occurrence of a user operation.

The present invention has been conceived in view of the above problem and aims to provide a priority information generating device for generating priority information used for setting such priorities that make it possible to improve the responsiveness to user operations, as well as an information processing device that controls the priorities in accordance with the generated priority information.

### Solution to Problem

In order to solve the above problem, one aspect of the present invention provides a priority information generating device for generating priority information regarding priorities of a plurality of tasks included in a multitask application to be run by an information processing device, the priority information generating device comprising: an event occurrence frequency information acquisition unit acquiring event occurrence frequency information that indicates an event occurrence tendency in association with an operation available for a user of the information processing device, the event occurrence tendency indicating, on a task-by-task basis, changes in frequency of event occurrence over time from when the operation has been received in the information processing device; a processing time information acquisition unit acquiring processing time information indicating respective times required for processing the tasks to be run in the information processing device; and a generating unit generating the priority information in accordance with the event occurrence frequency information and the processing time information, the generated priority information indicating timings for changing the priorities of the tasks in response to the operation and indicating priorities to be set at the timings.

### SUMMARY OF INVENTION

The above structure makes it possible to generate the priority information that indicates the timings for changing the priorities of the tasks in response to a user input (i.e. operation) and indicating priorities to be set at the timings, in accordance with the occurrence tendency of another user operation (event) following the user operation. Since the priorities can be specified for when the user operation has been occurred with the predicted next user operation taken into consideration, the responsiveness to user operations is improved than before.

### BRIEF DESCRIPTION OF DRAWINGS

FIG. 1 is a functional block diagram showing a functional structure of an information processing device.

FIG. 2 shows an example of an appearance of the information processing device.

FIG. 3 shows an example of contents of specific priority information in Linux™.

FIG. 4 shows an example of changes in frequency of event occurrence over time with respect to each content task.

FIG. 5 shows an example of a structure of event occurrence frequency information generated according to FIG. 4.

FIG. 6 is an example of a structure of processing performance information indicating processing time required for each task.

FIG. 7 shows an example of a structure of priority information that a priority information generating unit generates.

FIG. 8 is a flowchart showing a whole processing procedure performed by the information processing device according to Embodiment 1.

FIG. 9 is a flowchart showing processing performed by the priority information generating unit of the information processing device.

FIG. 10 is a flowchart showing priority calculation processing performed by the priority information generating unit of the information processing device.

FIG. 11 is a flowchart showing combining processing performed by a combining unit of the information processing device.

FIG. 12 is a flowchart showing processing performed by a multitask application of the information processing device.

FIG. 13 is a flowchart showing processing performed by a priority update unit according to the present invention.

FIG. 14 is a functional block diagram showing a functional structure of the priority information generating device.

FIG. 15 shows the frequency of event occurrence with respect to each task in a case with three or more tasks.

### DESCRIPTION OF EMBODIMENT

### Embodiment 1

The following describes an information processing device, which is a preferred embodiment of both a priority information generating device and a priority control device according to the present invention, with reference to the drawings.

An information processing device 1 is a small-sized information terminal, such as a mobile phone, a small-sized music player, and a PDA (Personal Digital Assistance), that includes a display and has a function of receiving a user operation. Note that the description herein assumes that Linux™ is installed as an OS (Operation System) of the information processing device 1.

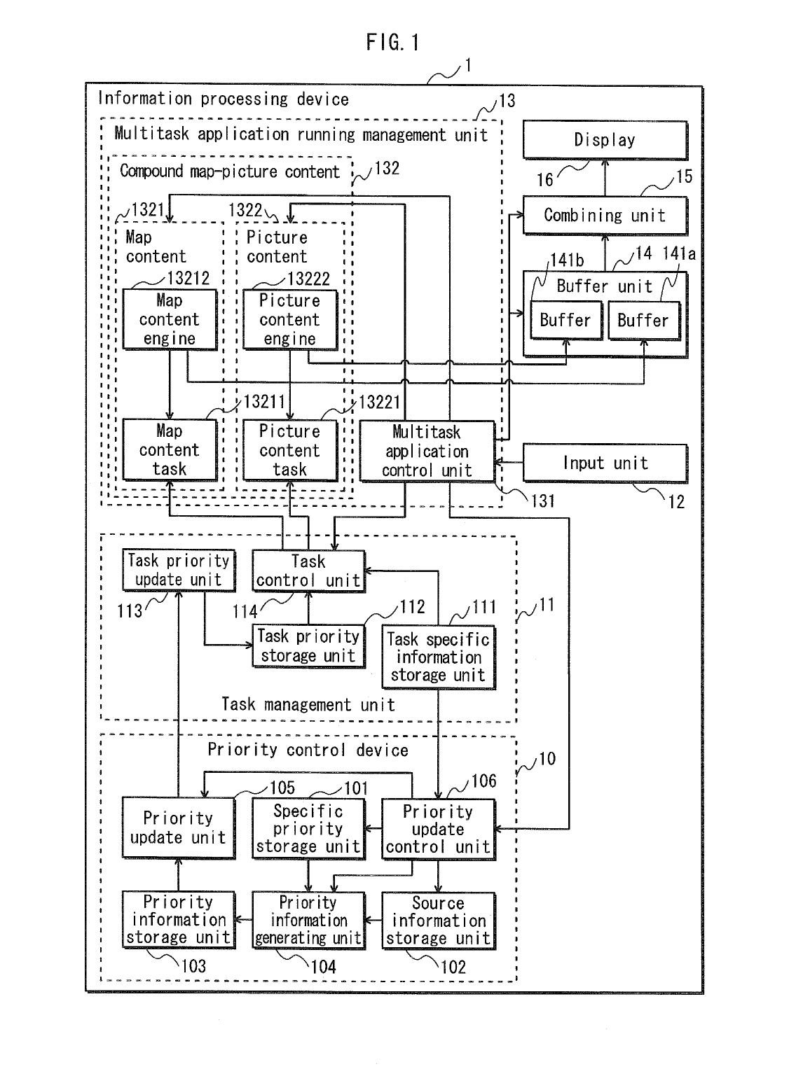

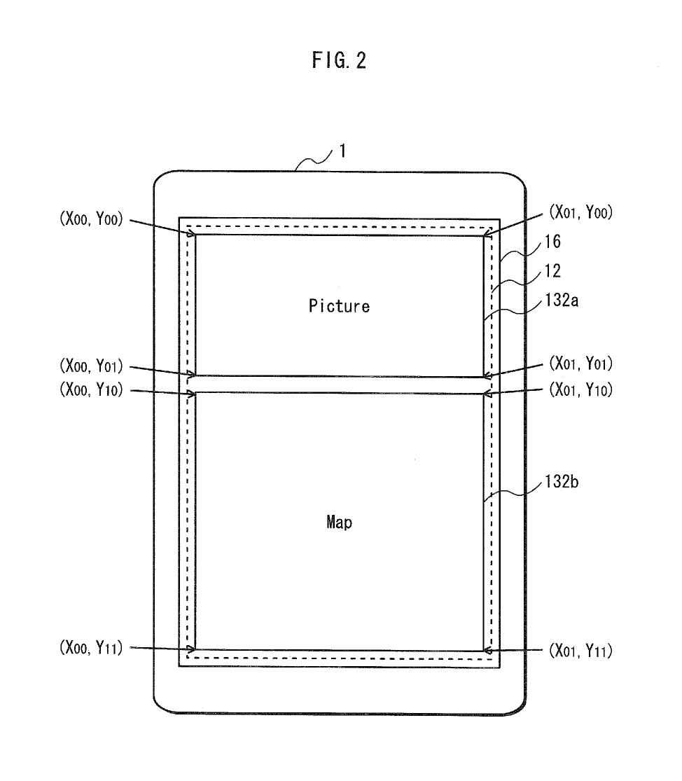

FIG. 1 is a functional block diagram showing a functional structure of the information processing device 1, and FIG. 2 is an appearance view of the information processing device 1 from an anterior view.

As shown in FIG. 2, the information processing device 1 displays, on a display 16, a picture 132a according to a picture content task and a map 132b according to a map content task. The information processing device 1 is provided with a touch pad of substantially a same size as the display 16, as an input unit 12 for receiving a user input. The touch pad has a physical coordinate system (i.e. a coordinate system having coordinate points represented by (X₀₀, Y₀₀), (X₀₀,Y₁₀), . . . in FIG. 2) by which a position of the received user operation is detected and by which whether the content to be operated is a picture or a map is determined.

As shown in FIG. 1, the information processing device 1 includes a priority control device 10, a task management unit 11, the input unit 12, a multitask application running management unit 13, a buffer unit 14, a combining unit 15, and the display 16.

The priority control device 10 has two functions. One is to generate priority information indicating priorities of a plurality of tasks to be run in the information processing device 1. The other is to perform update control on the priorities with use of the generated priority information. Specifically, the priority control device 10 includes a specific priority storage unit 101, a source information storage unit 102, a priority information storage unit 103, a priority information generating unit 104, a priority update unit 105, and a priority update control unit 106.

The specific priority storage unit 101 is a memory for storing specific priority information and realized as a RAM (Random Access Memory) or the like. The specific priority information is used for managing the tasks to be run in the information processing device 1. Providing that values indicating the priorities of the tasks are specified by the application, the specific priority information shows significance in terms of task management as indicated by the values.

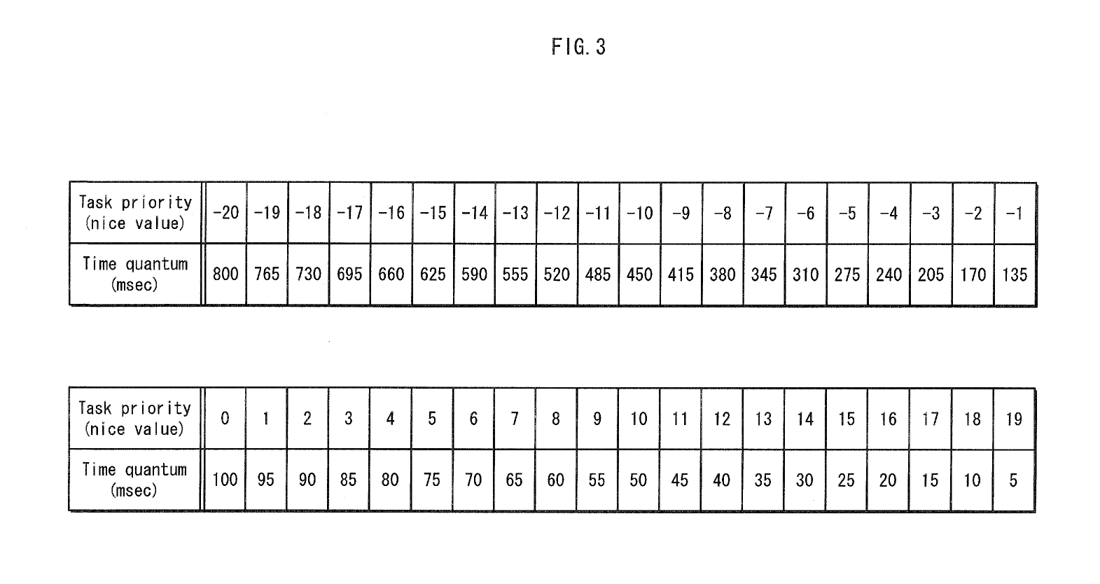

In a case of Linux™, the specific priority information indicates nice values (i.e. values set as arguments of the system call nice( ) in one-to-one correspondence with time quantums. The details of the specific priority information are described later with reference to FIG. 3.

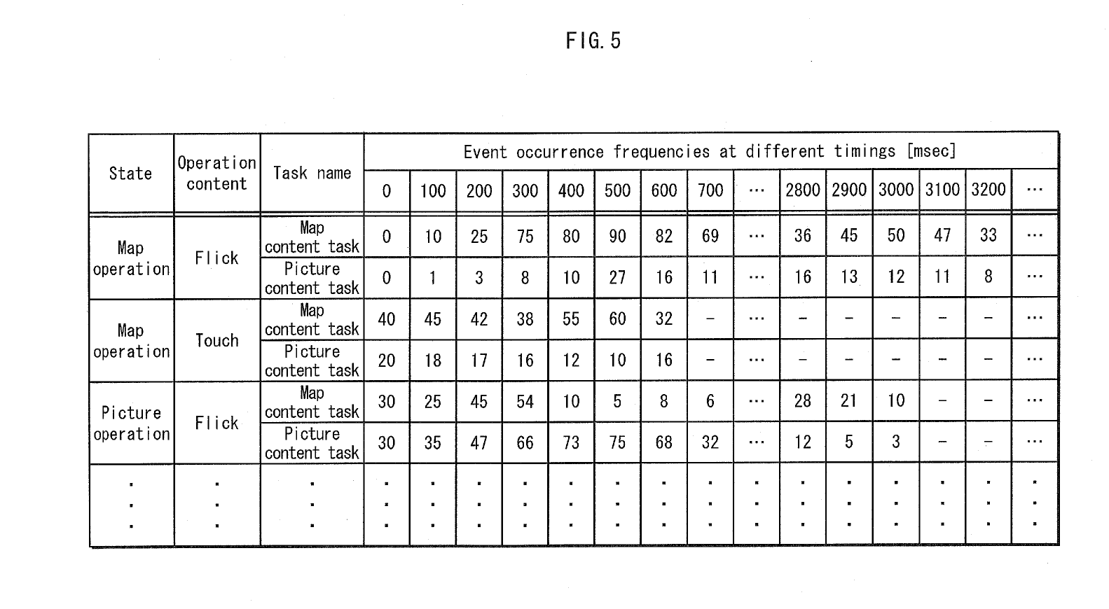

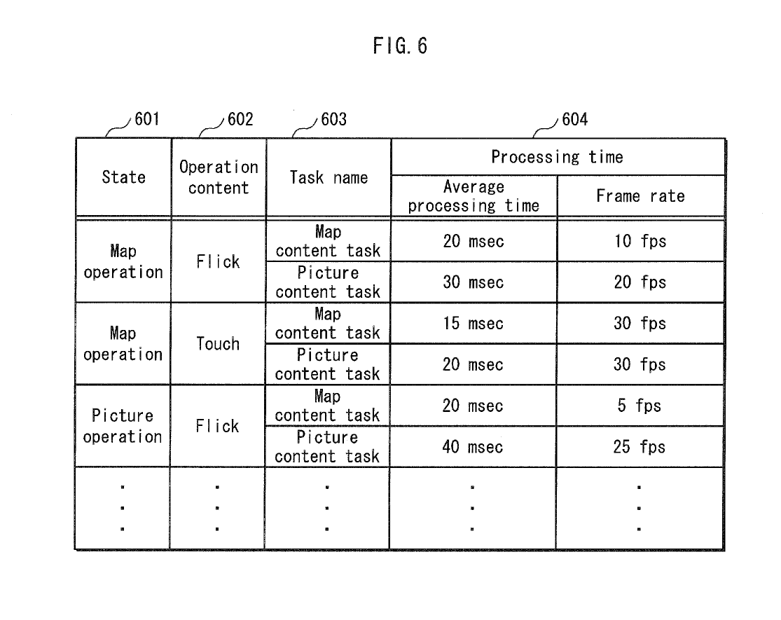

The source information storage unit 102 is a memory for storing source information, and realized by a RAM, for example. The source information is used for generating the priority information indicating the priorities of the tasks. The source information includes event occurrence frequency information and processing performance information. The event occurrence frequency information indicates frequencies of event occurrence on a task-by-task basis, and the processing performance information indicating processing performance with respect to each task. The details of the source information are described later with reference to FIGS. 5 and 6.

The priority information storage unit 103 has a function of storing the priority information generated by the priority information generating unit 104, and is realized by a memory such as a RAM, for example. The priority information indicates running states of the multitask application run by the information processing device 1, timings for changing the priorities of the content tasks in response to user operations available for a user of the information processing device 1, and priorities to be set at the timings.

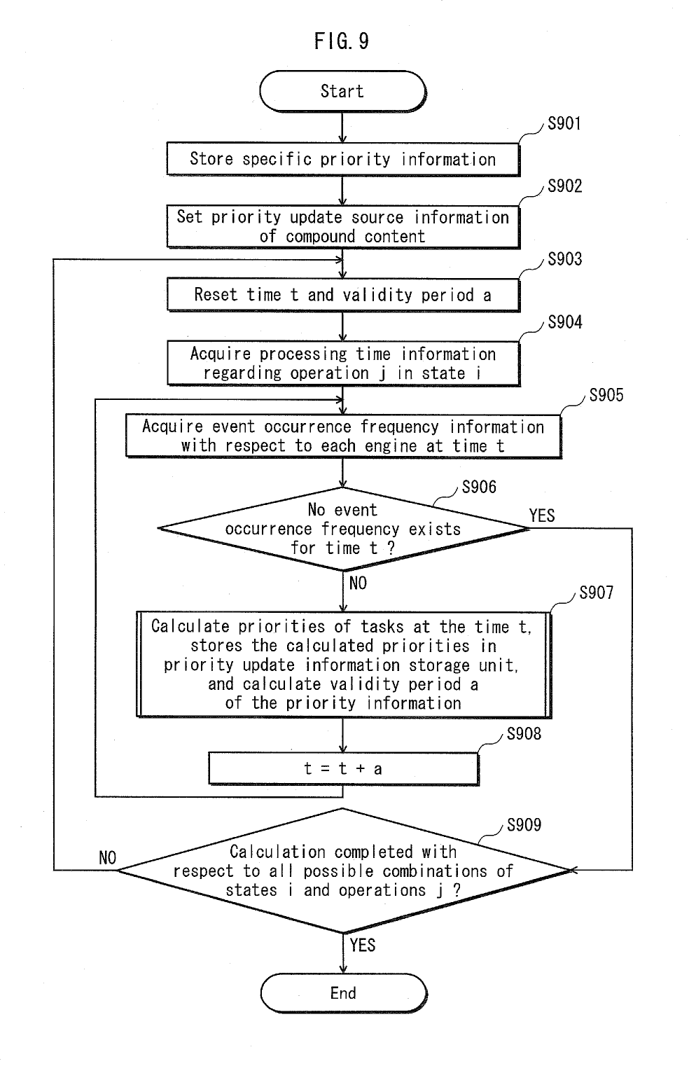

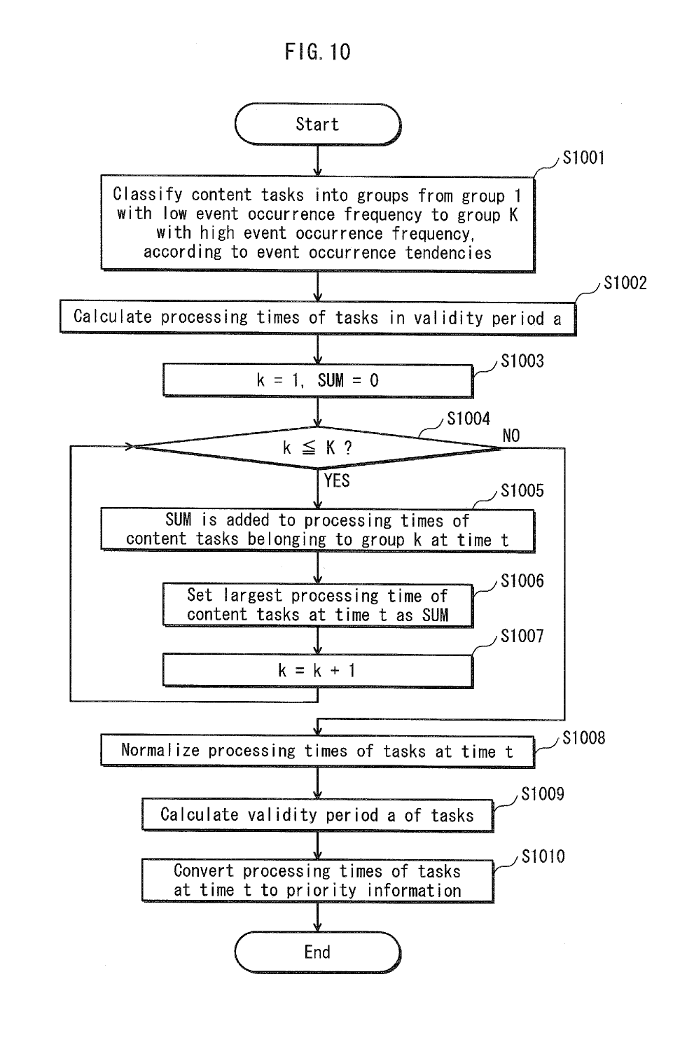

The priority information generating unit 104 has a function of generating the priority information based on the specific priority information stored in the specific priority information storage unit 101 and the source information stored in the source information storage unit 102, the generated priority information indicating the priorities of the tasks included in the multitask application to be run in the information processing device 1. The priority information generating unit 104 also has a function of storing the generated priority information in the priority information storage unit 103. The priority information generating unit 104 serves as the priority information generating device generating the priority information. The details of the priority information generating processing are described later with reference to FIGS. 9 and 10.

The priority update unit 105 has a function of requesting, in response to an instruction from the priority update control unit 106, the task management unit 11 to update the task priorities with use of the priority information stored in the priority information storage unit 103.

The priority update control unit 106 has a function of receiving, from the multitask application running management unit 13 of the information processing device 1, a multitask application's state and information regarding an event that has occurred, and a function of instructing, in accordance with the received state and event, the priority update unit 105 to start and end the priority update. The priority update control unit 106 also has a function of acquiring, as initialization processing before the priority information generating unit 104 generates the priority information, the specific priority information from the task specific information storage unit 111, and a function of storing the acquired specific priority information in the specific priority storage unit 101.

The task management unit 11 has a function of managing the tasks (i.e. the picture content task and the map content task in the present Embodiment), that is to say, a function of setting the priorities of the tasks. Specifically, the task management unit 11 includes the task specific information storage unit 111, a task priority storage unit 112, a task priority update unit 113, and a task control unit 114.

The task specific information storage unit 111 is a memory having a function of storing the specific priority information with respect to each task, and realized by a RAM, for example.

The task priority storage unit 112 is a memory having a function of storing the task priority information with respect to each task, and realized by a RAM, for example. In Linux™, the task priority information denotes the priority (nice value), the time quantum, and the time slice with respect to each task.

The task priority update unit 113 has a function of updating, in response to the request from the priority update unit 105, the tasks' task priority information stored in the task priority storage unit 112. In Linux™, the task priority update unit 113 performs processing of the system call nice( ). The system call nice( ) receives a nice value from an invoker of the system call, updates the task priority information with a time quantum corresponding to the received nice value, and set the updated task priority information in the task priority storage unit 112.

The task control unit 114 has a function of controlling, in accordance with the tasks' task priority information stored in the task priority storage unit 112, processing the tasks. Specifically, the task control unit 114 specifies a task to be currently run based on the values of the tasks set in the task priority information, and causes a specified task to execute processing. The task control unit 114 also updates the tasks' task priority information according to a processing state of each task. For example, the task control unit 114 updates time slice values based on the processing times of the tasks (by reducing a processing time required for a task from a time slice value assigned thereto).

The input unit 12 has functions of receiving a user operation and sending the received user operation to a multitask application control unit 131. Here, letting the input unit 12 be realized by a touch pad, the input unit 12 sends, to the multitask application control unit 131, an operation content (i.e. touch or flick) and a position (i.e. a coordinate touch point on the touch pad, or a coordinate point obtained by converting a user's touch position to a point in a coordinate system defined by a content running in the information processing device 1) of the received user operation.

The multitask application running management unit 13 has a function of running the tasks included in the multitask application that the information processing device 1 executes, and a function of managing the running states of the tasks. The multitask application running management unit 13 includes the multitask application control unit 131 and a compound map-picture content 132.

The multitask application control unit 131 has functions of receiving a user operation from the input unit 12 and sending an operation content of the received user operation to the compound map-picture content 132. The multitask application control unit 131 also has a function of notifying the priority update control unit 106 of the state of the compound map-picture content 132, as well as the fact that an event (e.g. the reception of the user operation) has been sent to the compound map-picture content 132. Furthermore, the multitask application control unit 131 has a function of creating the tasks included in the multitask application when the multitask application is activated, and a function of discarding the tasks when the multitask application ends.

Note that the compound map-picture content 132 denotes a content run by the information processing device 1. The compound map-picture content 132 includes a map content 1321 and a picture content 1322.

The map content 1321 includes a map content task 13211 and a map content engine 13212.

The map content task 13211 is generated by the multitask application control unit 131 when the compound map-picture content is activated. The map content task 13211 is associated with the map content engine 13212, and issues a render request to the map content engine 13212 and pauses at regular intervals in accordance with a frame rate (i.e. the number of times to render frames in one second) of the map content 1321.

The map content engine 13212 has a function of receiving from the multitask application control unit 131 the operation content of the user operation, and a function of changing the map's display state (e.g. longitude, latitude, or display magnification). The map content engine 13212 also has a function of determining whether to execute or end animation, such as map-scrolling, in accordance with the operation content of the user operation. Furthermore, the map content engine 13212 has functions of receiving the render request from the map content task 13211, generating an image specified by the render request, and rendering a next frame in a buffer 141a. The render content of the next frame is determined with reference to various information, such as the map's display state and presence of animation to be run. Since the map content task 13211 issues a render request in accordance with the frame rate of the map content 1321, a smooth map-scrolling animation etc. is realized.

The picture content 1322 includes a picture content task 13221 and a picture content engine 13222.

The picture content task 13221 is generated by the multitask application control unit 131 when the compound map-picture content is activated. The picture content task 13221 is associated with the picture content engine 13222, and issues a render request to the picture content engine 13222 and pauses at regular intervals in accordance with the frame rate (i.e. the number of times to render frames in one second) of the picture content 1322.

The picture content engine 13222 has a function of receiving from the multitask application control unit 131 the operation content of the user operation, and a function of changing the picture's display state (e.g. display position and size of the picture). The picture content engine 13222 also acquires image information of the picture to be displayed from an internal memory of the information processing device 1 or an external memory area (not shown) connected to the information processing device 1, and develops the acquired image information to a format (e.g. bitmap format) that the picture content engine 13222 is capable of rendering. As the external memory area, a nonvolatile memory medium such as an SD card can be used. Alternatively, if the information processing device 1 has a communication function, an external server or the like can store the image information as the external memory area. In this case, the image information is acquired through communication. Similarly to the map content engine 13212, the picture content engine 13222 also has functions of rendering a picture and running an animation. Furthermore, the picture content engine 13222 has a function of rendering a next frame in a buffer in accordance with a render request from the picture content task 13221.

The buffer unit 14 is a memory having a function of storing the images generated by the respective tasks included in the multitask application to be run, and also has a function of outputting the stored images to the combining unit 15. The buffer unit 14 includes the buffer 141a and the buffer 141b.

The buffer 141a has a function of storing an image that the map content engine 13212 has generated.

The buffer 141b has a function of storing an image that the picture content engine 13222 has generated.

The combining unit 15 has a function of combining an image stored in the buffer 141a and an image stored in the buffer 141b into a single image at regular intervals in accordance with an instruction from the multitask application control unit 131, and a function of outputting the combined image to the display 16. Note that the term “combining” herein refers to layer combining.

The display 16 has a function of displaying, on a screen for image display, an image output from the combining unit 15. The screen can be realized by an LCD (Liquid Crystal Display), a PDP (Plasma Display Panel), or an organic EL (Electronic Luminescence) display.

The functional structure of the information processing device 1 has been described above.

### <Data>

Now, a description is given of information for use in generating the priority information and the generated priority information.

FIG. 3 is a conceptual data diagram showing an example of a structure of the specific priority information. As shown in FIG. 3, the specific priority information indicates the nice values specifying the priorities that the application sets for the tasks in one-to-one correspondence with processing times called time quantums which can be assigned to the tasks through the nice values.

As shown in FIG. 3, nice values ranging from −20 to 19 are available for setting. Each nice value is assigned with a time quantum in the unit of msec, and as the nice value is smaller, the priority is higher and the time quantum of a longer processing time is assigned.

In FIG. 3, for example, the nice value “0” is assigned with the time quantum “100 msec”. Accordingly, when “0” is set to a task as the task priority, the task is assigned with the time quantum of 100 msec.

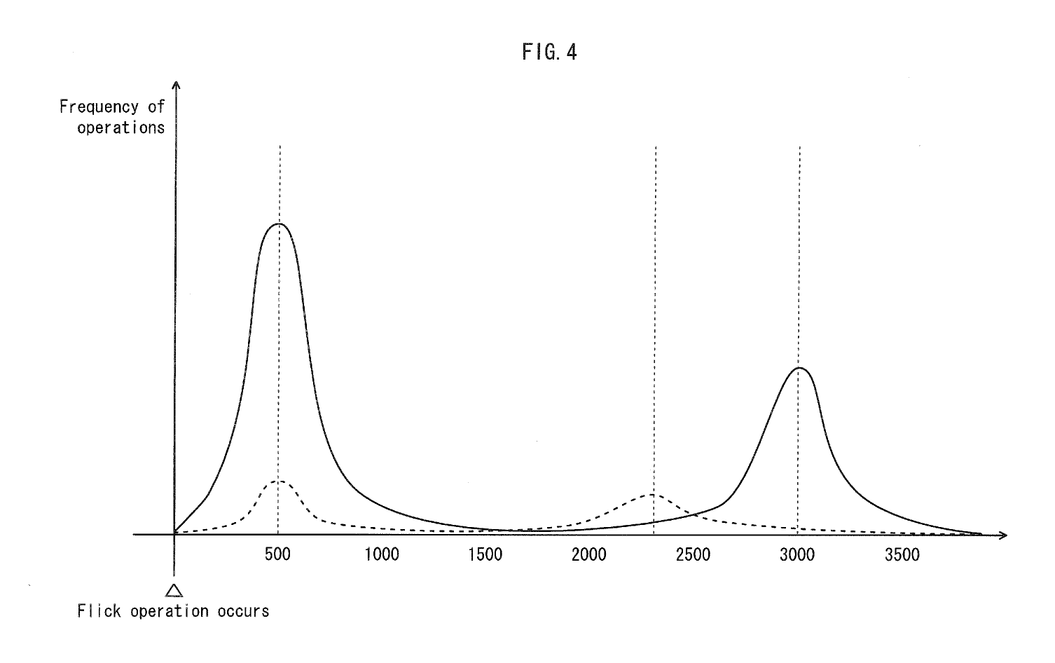

FIG. 4 is a graph showing an example of changes in frequency of event occurrence over time with respect to two tasks (namely, the picture content task and the map content task which are run in the information processing device 1) from when a flick operation from the user has been received in the information processing device 1. In FIG. 4, a vertical axis represents the frequency of event occurrence, and a horizontal axis represents time. A solid line in the figure represents an event occurrence tendency with respect to the map content task, and a dashed line represents the event occurrence tendency with respect to the picture content task.

As can be seen from FIG. 4, regarding the map content task, events are highly likely to occur both after 500 msec from when the flick operation has occurred and after 3000 msec from when the flick operation has occurred.

On the other hand, regarding the picture content task, events are highly likely to occur both after 500 msec from when the flick operation has occurred and after 2300 msec from when the flick operation has occurred.

FIG. 5 shows information indicating the event occurrence tendencies shown in FIG. 4 in specific numerical values, and is a conceptual data diagram of the event occurrence frequency information, which is included in the source information.

As shown in FIG. 5, the event occurrence frequency information includes, in association with each other, a state 501, an operation content 502, a task name 503, and an event occurrence frequency 504.

The state 501 specifies the multitask application's running state.

The operation content 502 specifies an operation content that is available for user input in a running state specified by the state.

The task name 503 specifies a task which is run by the multitask application.

The event occurrence frequency 504 specifies frequencies of event occurrence with respect to a task specified by the task name 503 per 100 msec from when a user operation specified by the operation content 502 has been received in a multitask application's running state specified by the state 501. The event occurrence frequencies herein are represented by numerical values based on relative frequencies ranging from 0 to 100.

In FIG. 5, “-” indicates that no event occurrence frequency exists.

Note that the event occurrence frequency information shown in FIGS. 4 and 5 may be either data input by the user, or information generated based on actual data obtained from an operation log that is a record of history of user operations.

FIG. 6 shows information indicating the processing performance with respect to the tasks when the tasks are run in the information processing device 1, and is a conceptual data diagram showing an example of data structure of the processing performance information, which is included in the source information.

As shown in FIG. 6, the processing performance information includes, in association with each other, a state 601, an operation content 602, a task name 603, and a processing time 604.

The state 601, the operation content 602, and the task name 603 are substantially the same as those in the event occurrence frequency information (see the state 501, the operation content 502, and the task name 503), and a description thereof is omitted here.

The processing time 604 specifies processing performance when an engine runs a task specified by the task name 603 in response to a user operation specified by the operation content 602 received in a multitask application's running state specified by the state 601. The processing time information 604 includes an average processing time and the frame rate with respect to each task.

The average processing time specifies an average length of time required for processing an event that occurs in the content task when an operation specified by the operation content has been received in an state specified by the state. The average processing time is obtained by running the task several times in practice and averaging out the whole length of time that has been spent for the running.

The frame rate specifies a frame rate when an operation specified by the operation content 602 is received in a state specified by the state 601.

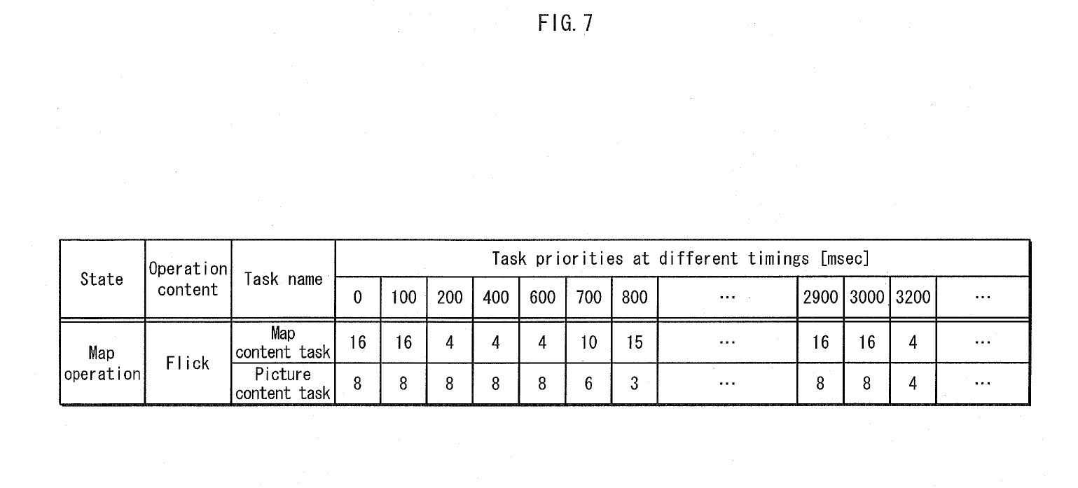

FIG. 7 is a conceptual diagram showing an example of data structure of the priority information that the priority information generating unit 104 of the information processing device 1 generates.

As shown in FIG. 7, the priority information includes, in association with each other, a state 701, an operation content 702, a task name 703, and a task priority 704.

The state 701, the operation content 702, and the task name 703 are substantially the same as those in the event occurrence frequency information (see the state 501, the operation content 502, and the task name 503), and a description thereof is omitted here.

The task priority 704 specifies the priorities to be assigned to the tasks at different timings when an operation specified by the operation content 702 has been received in a multitask application's running state specified by the state 701. The priorities herein are set as the arguments of the system call nice( ) in Linux™

Although FIG. 7 only shows the task priorities of a case where one operation specified by one operation content in association with one state occurs, the priority information generating unit 104 generates, as the priority information, the priorities of the tasks in association of all operation contents that can be received in multitask application's respective states.

### <Operations>

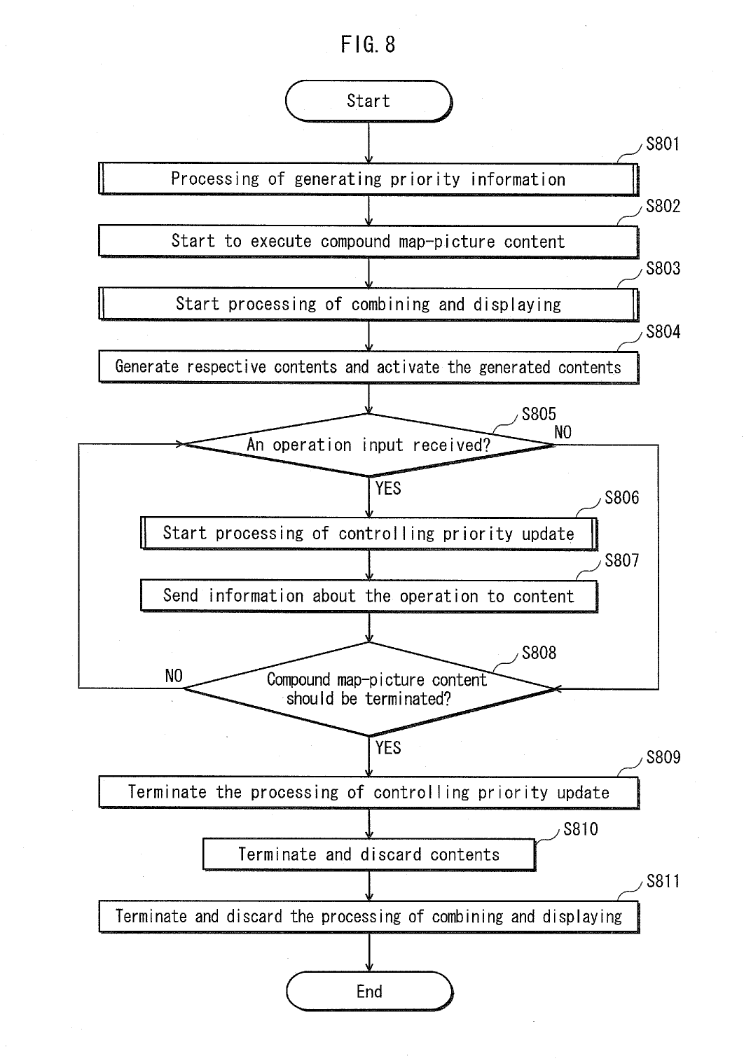

Next, a description is given of operations of the information processing device 1 according to the Embodiment with reference to flowcharts shown in FIGS. 8 to 13.

FIG. 8 is a flowchart showing an entire procedure of priority control processing performed by the information processing device 1.

As shown in FIG. 8, the information processing device 1 performs processing of generating the priority information with respect to each task (step S801). The details of the priority information generating processing are described later with reference to FIGS. 9 and 10.

After generating the priority information with respect to each task included in the multitask application, the multitask application running management unit 13 starts to execute the compound map-picture content (step S802). Firstly, the multitask application control unit 131 generates the buffer 141a and the buffer 141b which are allocated to the contents included in the compound map-picture content 132, in other words, ensures the buffer 141a and the buffer 141b for the content tasks in the memory area of the buffer unit 14. Secondly, the multitask application control unit 131 registers, in the combining unit 15, image data stored in the generated buffer 141a and image data stored in the generated buffer 141b as objects for display. In the registration, a display position/range (X₀₀-Y₀₀)-(X₀₁-Y₀₁) of the buffer 141a, the display position/range (X₀₀-Y₁₀)-(X₀₁-Y₁₁) of the buffer 141b, and an anteroposterior relation between the two buffers are set (note that this setting is necessary when the display ranges overlap with each other, and in the present Embodiment the display range of the image based on the data stored in the buffer 141a and that in the buffer 141b do not overlap with each other, and therefore the issue of which buffer comes on top of the other does not matter).

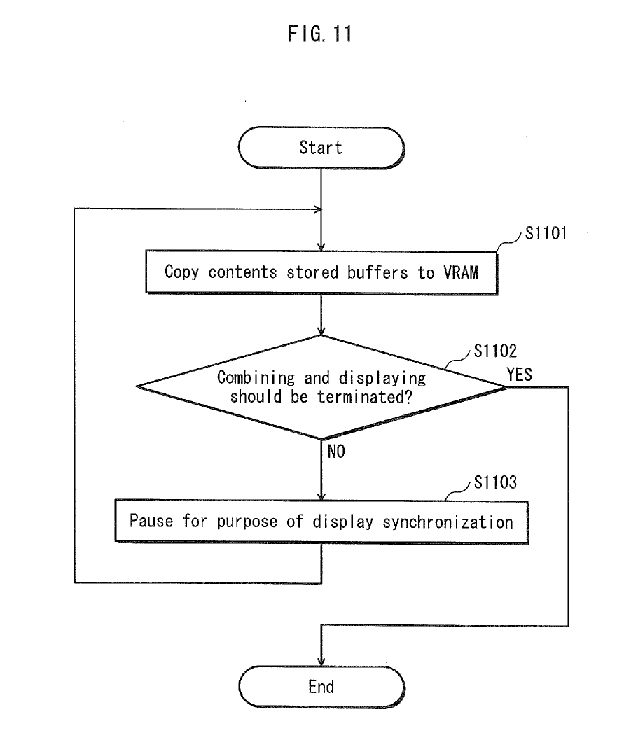

After the above setting is completed, the multitask application running management unit 13 instructs the combining unit 15 to start to combine the respective image data of the compound map-picture content stored in the buffer 141a and the buffer 141b, and display the combined image (step S803). The details of the combining and displaying processing is described later with reference to FIG. 11.

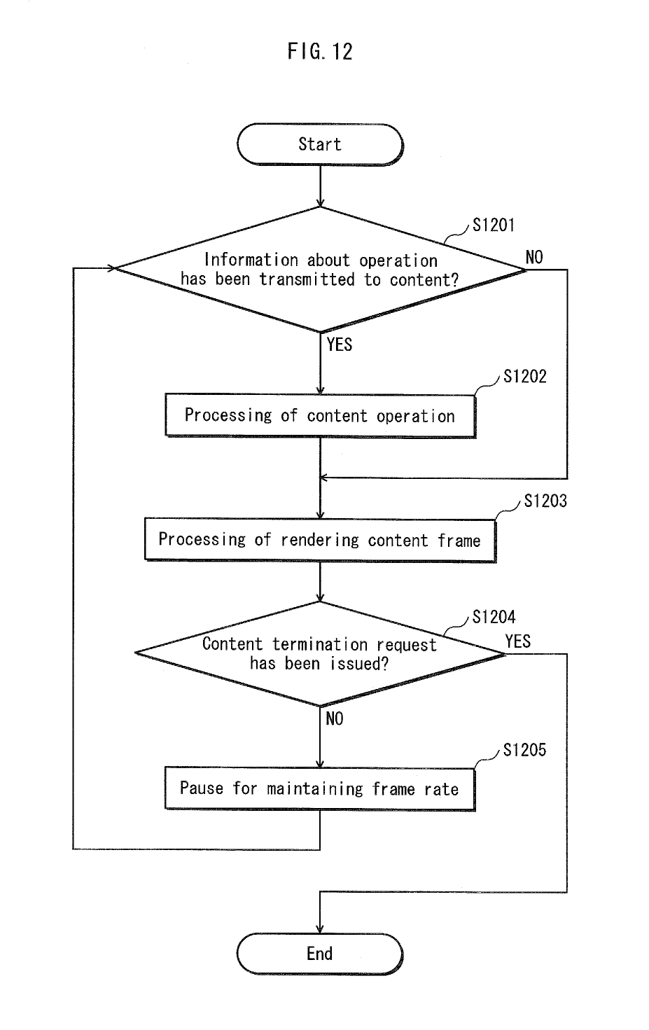

The multitask application running management unit 13 generates the map content 1321 and the picture content 1322 both included in the compound map-picture content 132, and activates the generated compound map-picture content 132 (step S804). Firstly, the multitask application running management unit 13 generates the map content task 13211 for running the map content and generates the picture content task 13221 for performing the picture content. In this generation processing, the multitask application running management unit 13 assigns the map content task 13211 with a main function defining an entry point for the map content engine 13212, and assigns the picture content task 13221 with the main function defining the entry point for the picture content engine 13222. Secondly, the multitask application running management unit 13 instructs the task management unit 11 to start to execute the map content task 13211 and the picture content task 13221. The task control unit 114 executes the processing of both the map content engine 13212 and the picture content engine 13222 in the time-sharing manner while switching tasks to be run, in accordance with the task priority information with respect to the map content task 13211 and the picture content task 13221. The details of processing contents of the content tasks are described later with reference to FIG. 12.

The multitask application running management unit 13 determines whether or not a user operation event has been received from the input unit 12 (step S805). When no user operation event has been received (NO in the step S805), the processing moves to step S808.

When a user operation event has been received from the input unit 12 (YES in the step S805), the multitask application running management unit 13 notifies the priority update control unit 106 of an event content of the received user operation and the state of the compound map-picture content 132 (i.e. a task running at that point and a control content of the task), and then the priority update control is performed (step S806).

Based on the event content of the user operation event received by the input unit 12, the multitask application running management unit 13 sends the user operation event to a content as a target for operation (step S807). The multitask application running management unit 13 determines which one of the map content 1321 and the picture content 1322 is the operation target, using focus information (i.e. information about the task to be processed) and operation position information (i.e. user's touch position on the touch pad, that is, the input unit 12). For example, the operation target is determined depending on the coordinate on which the touch pad operation received by the input unit 12 has been performed. Specifically, when the touch pad operation has been performed within the range of (X₀₀-Y₀₀)-(X₀₁-Y₁₀), the picture content 1322 is determined to be the operation target. On the other hand, when the touch pad operation has been performed within the range of (X₀₀-Y₁₀)-(X₀₁-Y₁₁), the map content 1321 is determined to be the operation target. Note that the focus information is provided in case a plurality of contents are displayed in an overlapped manner, and in this case, a content specified by the focus information is determined to be the operation target. Rendering is performed for the operation target content, in accordance with the operation content of the user operation event.

The multitask application running management unit 13 determines whether or not the processing of the compound map-picture content 132 should be terminated (step S808). This determination depends on whether or not a user input instructing termination processing of the multitask application (e.g. an End Key press) has been received. When the termination processing is not necessary (NO in the step S808), that is to say, when a termination instruction from the user has not been received, the processing returns to the step S805.

On the other hand, when it is determined that the termination processing of the compound content is necessary (YES in the step S808), the multitask application running management unit 13 requests the priority update control unit 106 to terminate the priority update control processing (step S809).

Then, the multitask application running management unit 13 issues termination requests to the map content 1321 and the picture content 1322 to terminate the processing of the contents, and subsequently, discards the map content task 13211 and the picture content task 13221 (step S810).

Finally, the multitask application running management unit 13 issues a combining processing termination request to the combining unit 15. In response to the termination request, the combining unit 15 terminates the combining processing. Furthermore, the multitask application running management unit 13 discards the buffer 141a and the buffer 141b generated in the buffer unit 14.

The entire procedure of the priority control processing has been described above.

Now then, a description is given of the details of various processing steps involved in the priority control processing shown in FIG. 8.

To begin with, with reference to FIGS. 9 and 10, the priority information generating processing in the step S801 is explained.

FIG. 9 is a flowchart showing the priority information generating processing performed by the priority information generating unit 10.

As shown in FIG. 9, the priority update control unit 106 reads the specific priority information shown in FIG. 3 from the task specific information storage unit 111, and stores the read specific priority information in the specific priority storage unit 101 (step S901).

Subsequently, the priority update control unit 106 stores the source information of the compound content in the source information storage unit 102 (step S902). It should be assumed that the source information herein is that shown in FIGS. 5 and 6 and has been stored by the priority update control unit 106. Subsequently, the priority update control unit 106 requests the priority information generating unit 104 to generate the priority information.

In response to the priority information generation request, the priority information generating unit 104 starts to generate the priority information with respect to the content tasks appropriate for the states and the operation contents which are included in the source information stored in the source information storage unit 102.

The priority information generating unit 104 resets a value of an internal variable t to “0”, where the variable t specifying timings for setting the priorities and used for time management. The priority information generating unit 104 also initializes an internal variable a, where the internal variable a specifying how long the priorities should be valid (step S903). A default value of the internal variable a is a value divisible by an interval value defined by the event occurrence frequencies included in the event occurrence frequency information, and can be any value as long as the value is not significantly far from the range of time quantum values described in the specific priority information. In the present Embodiment, the default value of a is 100 msec.

The priority information generating unit 104 acquires, from the source information storage unit 102, the processing time information regarding an operation j in a state i (step S904). Here, the state i denotes one if the states included in the state information shown in FIGS. 5 and 6, and the operation j denotes an operation associated with the state i and is one of the operation contents shown in FIGS. 5 and 6. As an example, let the state i be “map operation”, and the operation j be “flick”, and assume that the priorities are to be calculated with respect to the map content task. In this case, the priority information generating unit 104 acquires “20 msec” as the average processing time, and “10 fps (frame per second)” as the frame rate.

Subsequently, the priority information generating unit 104 acquires, from the source information storage unit 102, the event occurrence frequency information with respect to each task at time t (step S905). As an example, let the state i be “map operation”, the operation j be “flick, and the time t be “0”, and assume that the priorities are to be calculated with respect to the map content task. In this case, as shown in FIG. 5, “0” is acquired as the event occurrence frequency.

At this time, when the priority information generating unit 104 determines that no event occurrence frequency exists for the time t (i.e. “-” is described for the time t in FIG. 5) (YES in step S906), the processing moves to step S909. The reason is that, when no event occurrence frequency exists, the priority information generating unit 104 determines that no event is to occur from then on.

When an event occurrence frequency exists (NO in step S906), the processing moves to step S907.

The priority information generating unit 104 calculates the priorities of the tasks at the time t, stores the calculated priorities in the priority information storage unit 103, and calculates a validity period a of the priority information (step S907). The details of the above processing is described later with reference to FIG. 10.

The priority information generating unit 104 calculates a new time t by adding the calculated validity period a to the time t, as a next timing for changing the priorities (step S908). Then, the processing returns to the step S905.

On the other hand, when no event occurrence frequency exists for the time t (YES in step S906), the priority information generating unit 104 determines whether or not the priorities of the tasks and the timings for changing the priorities have been calculated with respect to all possible combinations of the states i and the operations j. This determination is performed by detecting whether or not the priority information associated with the respective states and the respective operation contents included in the source information has been stored in the priority information storage unit 103.

When the priorities of the tasks and the timings for changing the priorities have not been calculated with respect to all possible combinations of the states i and the operations j (NO in step S909), the contents of the state i and the operation j are changed, and the processing returns to the step S903. When the priorities of the tasks and the timings for changing the priorities have been calculated with respect to all possible combinations of the states i and the operations j (YES in step S909) the priority information generating processing ends.

Now, the details of the calculation of the priority and the validity period a performed in the step S907 of FIG. 9 are explained with reference to a flowchart of FIG. 10.

To begin with, the priority information generating unit 104 classifies the content tasks into a plurality of groups from a group 1 with a low event occurrence frequency to a group K with a high event occurrence frequency, according to different levels of frequency of event occurrence with respect to the content tasks (step S1001). In the present Embodiment, K is 3. In other words, the content tasks are classified into three groups composed of a high, a medium, and a low event occurrence frequency group. The purpose of the classification processing is to make the task priority calculation easy. In the present Embodiment, the event occurrence frequencies are represented by relative numerical values ranging from 0 (meaning that an event does not occur at all) to 100 (meaning that an event certainly occurs). Accordingly, in the group classification processing herein, the content tasks with the event occurrence frequencies 0 to 33 are classified into the group 1, the content tasks with the event occurrence frequencies 34 to 66 are classified into the group 2, and the content tasks with the event occurrence frequencies 67 to 100 are classified into the group 3. Note that although in this explanation the event occurrence frequencies are substantially equally distributed into the respective groups, the event occurrence frequencies do not necessarily need to be equally distributed. To put it more clearly with an example of classification of the event occurrence frequencies shown in FIG. 5, when the time t=0, the event occurrence frequencies of both the map content task and the picture content task are 0, and both of the tasks are classified into the group 1. However, when the time t=500, the event occurrence frequency of the map content task is 90, and the event occurrence frequency of the picture content task is 27. Accordingly, the map content task is classified into the group 3, and the picture content task is classified into the group 1 at the time t=500.

Next, the priority information generating unit 104 calculates basic processing times PTS_{X} of the tasks (i.e. respective times basically required for processing the tasks) from the current time t to time t+a according to the following (Equation 2) (step S1002).

$$\begin{matrix}[ Math 2 ] & \\ {PTS}_{x} = {MP}_{x} \times {FR}_{x} \times \frac{{a}_{0}}{1000} & ( Equation 2 )\end{matrix}$$

The priority information generating unit 104 initializes the variable k with 1, and initializes the variable SUM with 0 (step S1003).

The priority information generating unit 104 determines whether the variable k is less than or equal to K (K is a total number of the groups) (step S1004).

When the variable k is less than or equal to the number K (YES in step S1004), the basic processing times PTS_{X} of tasks belonging to a group k is added with a value of the variable SUM at that time, and thus obtained value is set as the time quantum value of the tasks (step S1005). The value of the variable SUM indicates the longest time among the time quantum values of content tasks belonging to a group with one event occurrence frequency level lower than the group k. By adding the value designated by the variable SUM, the priority of the tasks belonging to the group k is made higher than that of the tasks belonging to the group with a lower event occurrence frequency level than the group k.

Next, the priority information generating unit 104 sets the largest time quantum value among the time quantum values of the content tasks belonging to the group k as the variable SUM (step S1006). By doing so, the priority of tasks belonging to a group with a higher event occurrence frequency level, for which the priority is to be calculated next, is made higher.

Then, the priority information generating unit 104 increments the variable k (step S1007), and the processing returns to the step S1004.

On the other hand, when the variable k is greater than the number K of the groups (NO in step S1004), that is to say, when the time quantum values have been calculated for all the tasks for all the groups, the processing moves on to step S1008.

The priority information generating unit 104 normalizes the time quantum values of the tasks (step S1008). This normalization refers to processing of reducing the time quantum values of the tasks by a constant rate, by dividing the time quantum values of the tasks by a constant value (which is greater than 1) when one or more time quantum value among all the time quantum values calculated for the tasks exceeds a predetermined value (e.g. 300 msec). The need to normalize the time quantum values may arise due to the following problem in the aforementioned processing for making high the priority of tasks belonging to a high event occurrence frequency group. That is to say, the higher the event occurrence frequency of a group that the tasks belong to is, the more time quantum values, which are set for other tasks belonging to groups with lower event occurrence frequencies, are added to the task. Eventually, the time quantum value of the tasks might become rather large. When such a large value is set as the time quantum value, the setting of the time quantum cannot be validated until the time slices are completely consumed, which makes it difficult to conduct a thorough control over the time quantum value appropriate for situation. The above problem can be avoided by performing the normalization processing. Meanwhile, when a time quantum value after the division does not match any of the time quantum values described in the specific priority information shown in FIG. 3, the time quantum value is rounded up to the closest time quantum value.

Next, the priority information generating unit 104 calculates the validity period a according to the following (Equation 3).

$$\begin{matrix}[ Math 3 ] & \\ a = \frac{{PT}_{max}}{{PTS}_{max}} \times {a}_{0} \times β & ( Equation 3 )\end{matrix}$$

In the (Equation 3), PTₘₐₓ represents the time quantum value necessitating a longest processing time among the time quantums ultimately calculated for the tasks. Furthermore, PTSₘₐₓ represents a longest basic processing time among all the basic processing times (i.e. products of the processing times and the frame rates) calculated for the tasks. a₀ is a default value for calculating the validity period a, and 100 (msec) is substituted for a₀ here. β is a real number ranging from 0 to 1. The value β may be either invariable or variable. However, when β is set to be a variable calculated based on the event occurrence frequencies, the value of the validity period a may be varied in accordance with the event occurrence frequencies. When the validity period a calculated according to the (Equation 3) cannot be divided evenly by an interval (100 msec) defined by the event occurrence frequencies, the calculated value a is rounded up until it reaches a value dividable by the interval.

Then, based on the ultimately calculated time quantum value and the specific priority information of FIG. 3, the priority information generating unit 104 specifies the priorities to be set for the tasks (step S1010). Specifically, the priority information generating unit 104 retrieves, from the specific priority information of FIG. 3, a time quantum value matching the time quantum value calculated for a task, and sets the associated priority as the priority of the task.

By the processing of FIG. 10, the priorities of the tasks at a time t and the validity period a of the priorities can be calculated. By calculating the validity period a, the next timing for changing the priorities can be calculated from t+a. The above procedure is repeated with respect to all the states and all the operation contents, until the respective values of the event occurrence frequencies reach “-”. As a result, such priority information is generated that indicates the timings for changing/setting the priorities of the tasks and priorities to be set at the timings in association with the states and the operation contents available in the states.

The following explains a specific example of calculating the priorities of the tasks, where the state i is “map operation”, and the operation j is “flick”, with reference to the event occurrence frequency information of FIG. 5 and the processing performance information of FIG. 6. The explanation herein focuses on the processing for calculating the priorities from the time t=0 and the time t=600 as the specific example.

Firstly, an explanation is given of a case where the time t=0. The processing time (referred to as PT₁) of the map content task is 20 msec (20×10×100/1000) according to the (Equation 2). Similarly, the processing time (referred to as PT₂) of the picture content task is 60 msec (30×20×100/1000). Furthermore, the event occurrence frequency of the content tasks at the time t=0 are both 0, and therefore both the contents belong to the group 1. Since both the tasks belong to the same group, the addition of the processing time according to the step S1005 is not performed. Accordingly, PT₁ remains 20 msec, and PT₂ remains 60 msec. Moreover, letting β=0.5, then a is 50 msec ((60/60)×100×0.5 according to the (Equation 3). However, since a is rounded up to the value evenly divided by the interval (100 msec) defined by the event occurrence frequencies included in the source information, which is used for priority update, a eventually becomes 100 msec. The task priorities (referred to as TPₓ) to be set for the tasks are 16 for TP₁, and 8 for TP₂, according to FIG. 3. Regarding the time t, a (=100 msec) is added, and then t=100.

Secondly, an explanation is given of a case where the time t=100. In this case also, the processing time PT₁ of the map content task is 20 msec, and the processing time PT₂ of the picture content task is 60 msec. Furthermore, the event occurrence frequency of the map content task at the time t=100 is 10, and the event occurrence frequency of the picture content task at the time t=100 is 1, and therefore both the contents belong to the group 1. Since both the tasks belong to the same group, the addition of the processing time according to the step S805 is not performed. Subsequently, the same processing as that in the time t=0 is performed, and TP₁ is 16, and TP₂ is 8. Regarding the time t, a (=100 msec) is added, and then t=200 msec.

Regarding a case where the time t=200 also, the processing time PT₁ of the map content task is 20 msec, and the processing time PT₂ of the picture content task is 60 msec. Furthermore, the event occurrence frequency of the map content task at the time t=200 is 45, and the event occurrence frequency of the picture content task at the time t=200 is 5, and therefore the map content task belongs to the group 2, and the picture content task belongs to the group 1. Accordingly, PT₁ is added with PT₂, which is the value for a lower group, and then PT₁ is 80 msec, and PT₂ is 60 msec. Moreover, a is 200 msec according to the (Equation 3). The task priorities TPₓ to be set for the tasks are 4 for TP₁, and 8 for TP₂, according to FIG. 3. Regarding the time t, a (=200 msec) is added, and then t=400 msec.

Regarding a case where the time t=400 also, the processing time PT₁ of the map content task is 20 msec, and the processing time PT₂ of the picture content task is 60 msec. Furthermore, the event occurrence frequency of the map content task at the time t=400 is 80, and the event occurrence frequency of the picture content task at the time t=400 is 9, and therefore the map content task belongs to the group 3, and the picture content task belongs to the group 1. Subsequently, the same processing as that in the time t=200 is performed, and TP₁ is 4, and TP₂ is 8. Regarding the time t, a (=200 msec) is added, and then t=600 msec.

Regarding a case where the time t=600 also, the processing time PT₁ of the map content task is 20 msec, and the processing time PT₂ of the picture content task is 60 msec. Furthermore, the event occurrence frequency of the map content task at the time t=600 is 80, and the event occurrence frequency of the picture content task at the time t=600 is 9, and therefore the map content task belongs to the group 3, and the picture content task belongs to the group 1. Subsequently, the same processing as that in the time t=400 is performed, and TP₁ is 4, and TP₂ is 8. Regarding the time t, a (=200 msec) is added.

The above processes are performed to generate the priority information as shown in FIG. 7.

Next, a description is given of the details of the combining processing performed by the combining unit 15 in the step S803 of FIG. 8 to combine the image data rendered in the buffer 141a and the image data rendered in the buffer 141b.

In response to the instruction from the multitask application control unit 131, the combining unit 15 combines the contents stored in the buffer 141a and in the buffer 141b to write the combined contents into a VRAM (Video Random Access Memory) (step S1101), and outputs the combined contents to the display 16.

The combining unit 15 determines whether a termination request has been received from the multitask application control unit 131 (step S1102). When no termination request has been received (NO in step S1102), the combining unit 15 pauses (sleeps) for the purpose of display synchronization, and after the pause (sleep), the processing returns to the step S1102. The display 16 updates the screen at a frequency of several tens of Hz. Without appropriate control over the screen update timing and the VRAM content update timing by the combining unit 15, the screen update might occur during the VRAM update, possibly resulting in a flicker on the screen. To avoid the problem, the screen update timing and the VRAM content update timing is controlled by the combining unit 15 pausing the processing for an appropriate length of time.

When the termination request has been received (YES in step S1102), the combining unit 16 terminates the combining and displaying processing.

The details of the combining processing have been described above.

FIG. 12 is a flowchart showing operations in the information processing device 1 with respect to specific processing of the map content 1321 or the picture content 1322 performed when a user operation has been received in the step S805 of FIG. 8. The following describes, as one example, the case of the map content 1321 with reference to FIG. 12. Note that the picture content 1322 operates similarly as the map content 1321, and therefore a description is given of only a point different from the case of the map content 1321.

The map content engine 13212 determines whether or not a user operation event has been transmitted to the map content (step S1201). This determination depends on whether or not any transmission has been performed in accordance with an operation input from the user in the step S805 of FIG. 8. When no user operation event has been transmitted to the map content (NO in step S1201), the processing moves onto step S1203.

On the other hand, when a user operation event has been transmitted to the map content (YES in step S1201), the map content engine 13212 performs processing in accordance with the transmitted user operation event, and updates a map content's internal state (step S1202). For example, when the transmitted user operation is “flick operation”, the map content engine 13212 updates the map content's internal state to “scrolling animation”, and calculates a map display position PD after the scrolling based on displacements of the flick operation in an X-axis and a Y-axis direction. Furthermore, the map display position PS before the scrolling is set to be a current map display position PN, animation start time TS is set to be a current time TN, and animation end time TE is set to be a value obtained by adding scrolling animation time TA to TS. In this way, necessary input information for frame rendering processing in the next step S1203 is generated.

In accordance with the input information such as the internal state, the map content engine 13212 renders in the buffer 141a a content to be displayed as the next frame (step S1203). The map content engine 13212 updates the value of the map display position PN in accordance with the internal state of the map content 1321. For example, when the internal state is “scrolling animation”, update is performed according to the following (Equation 4).

$$\begin{matrix}[ Math 4 ] & \\ PN = \frac{( TN - TS )}{( TD - TS )} \times ( PD - PS ) + PS & ( Equation 4 )\end{matrix}$$

Subsequently, the map content engine 13212 acquires map information of the current position PN either via the Internet or from map information stored in a storage unit (not shown) of the information processing device 1. The map content engine 13212 converts the acquired map information into a format that can be rendered to the buffer 141a if necessary, and then writes the converted data into the buffer 141a.

The map content engine 13212 determines whether or not the termination request has been issued from the multitask application running management unit 13 (step S1204). When the termination request has not been issued (NO in step S1204), the map content engine 13212 issues a request for a pause, which is necessary for maintaining the frame rate of the map content 13211. In the case of Linux™, for example, issuing the request corresponds to calling the system call sleep( ). When the frame rate set in the map content 1321 is 20 fps (frame per second), the map content engine 13212 pauses for a length of time obtained by subtracting a length of time spent for the steps S1201 through S1204 from 50 msec (step S1205), and after the pause, the processing returns to the step S1201.

When the termination request has been issued to the map content 1321 (YES in step S1204), the map content 1321 is terminated, and the processing ends.

Regarding the case of the picture content 1322, the processing in the steps S1201 and S1202 are different from the case of the map content 1321. In the case of the picture content 1322, the internal state concerning picture display, scrolling, and display size/position of each picture are calculated in the step S1201. In the step S1202, the calculated values are utilized for rendering in the buffer 141b.

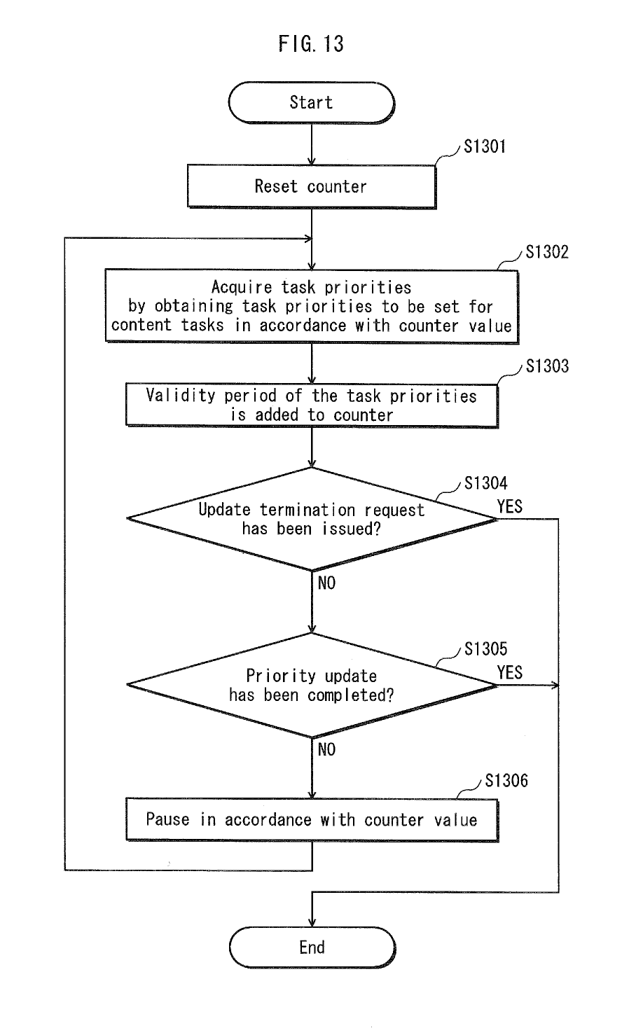

FIG. 13 is a flowchart showing the details of the priority update control processing performed by the information processing device 1 in the step S806 of FIG. 8.

The priority update unit 105 resets a value rt of a counter counting the validity period of the priority control (step S1301).

The priority update unit 105 acquires, from the priority information storage unit 103, the task priorities to be set for the content tasks at time rt, and sets the priorities of the content tasks (step S1302). For example, assume that the priority information shown in FIG. 7 is adopted. When the time rt=0, the priority update unit 105 acquires the priority value 16 for the map content task, and acquires the priority value 8 for the picture content task. The priority update unit 105 sends the acquired priorities to the task priority update unit 113 so that the task priorities of the tasks are updated with the acquired values. In the case of Linux™, the priority update unit 105 calls nice( ) for the tasks while setting the respective values specified by the task priorities as the arguments.

The validity period of the task priorities set as above is added to the variable rt (step S1303). In other words, as shown in FIG. 7, a value corresponding to a next timing for setting the priorities is set. For example, when rt=0 in FIG. 7, rt is added with 100.

When a priority update termination request has been received from the priority update control unit 106 (YES in step S1304), the priority update unit 105 terminates the priority update control processing. When the priority update termination request has not been received from the priority update control unit 106 (NO in step S1304), the priority update unit 105 determines whether or not the priority update control according to the priority information stored in the priority information storage unit 103 has been completed (step S1305). In other words, the determination as to whether or not to end the priority update control depends on whether or not there still remains task priorities to be set next. For example, assume a case where the priority update control is performed according to the priority information shown in FIG. 7. In this case, the priority update control processing is ended when rt>3200.

When the priority update unit 105 determines that the priority update control is to end (YES in step S1305), the priority update control processing is ended. When the priority update unit 105 determines that the priority update control is not to end (NO in step S1305), the priority update unit 105 pauses for a length of time from the start of the priority update control to the value of rt, and after the pause, the processing returns to the step S1302. The reason is that the priority update control processing does not need to be performed until the time indicated by rt passes.

With the processing shown in FIG. 13 performed, appropriate task priorities can be set in accordance with the changes in frequency of event occurrence over time with respect to each content task. Consequently, when a key event has occurred, a content task that is to process the key event is able to perform processing with a higher priority. Accordingly, the user operability is improved. In particular when a user operation has been received, the responsiveness to another user operation following the user operation is improved than before.

### <Supplementary Description>

Although the preferred Embodiment of the present invention has been described above, the present invention is not of course limited to the above Embodiment. The following describes other modification examples of the present invention than the above Embodiment.

(1) Although in the above Embodiment the description is given of the example where information processing device is the small-sized mobile terminal, the information processing device is not limited to the small-sized mobile terminal. The information processing device can be any device that is mounted with a single processor or a small number of processors and is capable of running the multitask application including a larger number of tasks than that of the processors mounted in the device. Other examples of the information processing device than the small-sized mobile terminal include a PC operated by a single processor.

(2) Although in the above Embodiment the OS of the information processing device is Linux™, the information processing device may be operated by any OS, such as Windows™ and MAC OS™, which is capable of multitask control.

(3) Although the information processing device 1 in the above Embodiment includes the priority information generating unit 104, the priority information generating unit 104, which serves as the priority information generating device, does not need to be included in the information processing device 1.

For example, the information processing device may transmit, to the priority information generating device that is external to the information processing device, information regarding a plurality of tasks to be run by the information processing device, a user input available during running of the tasks, and processing performance with which the tasks are run. In this case, the priority information generating device has functions equivalent to those of the priority information generating unit 104 described in the Embodiment 1, and generates the priority information based on the transmitted information and the event occurrence frequency information which has been input in advance. The priority information generating device transmits the generated priority information to the information processing device. In accordance with the transmitted priority information, the information processing device updates and sets the priorities of the tasks.

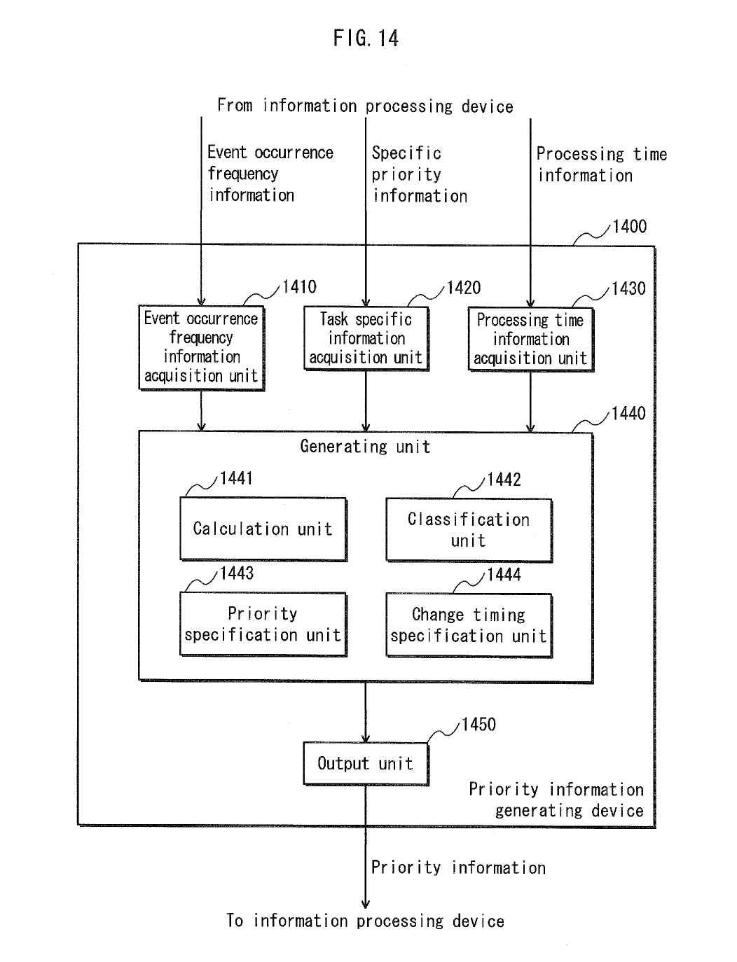

(4) FIG. 14 shows an example of a detailed structure of the above priority information generating device. As shown in FIG. 14, a priority information generating device 1400 includes an event occurrence frequency information acquisition unit 1410, a task specific information acquisition unit 1420, a processing time information acquisition unit 1430, a generating unit 1440, and an output unit 1450.

The event occurrence frequency information acquisition unit 1410 has a function of acquiring the event occurrence frequency information shown in FIG. 5 from the information processing device, and a function of transmitting the acquired event occurrence frequency information to the generating unit 1440. Note that in this case the information processing device either generates the event occurrence frequency information from the operation log in the own device in advance, or stores the event occurrence frequency information which has been input from a user. The event occurrence frequency information acquisition unit 1410 may also acquire the event occurrence frequency information through direct input by, for example, an operator.

The task specific information acquisition unit 1420 has a function of acquiring the specific priority information shown in FIG. 3 from the information processing device, and a function of transmitting the acquired specific priority information to the generating unit 1440.

The processing time information acquisition unit 1430 has a function of acquiring the processing time information shown in FIG. 6 from the information processing device, and a function of transmitting the acquired processing time information to the generating unit 1440.

The generating unit 1440 has functions substantially equivalent to those of the priority information generating unit 104 described in the above Embodiment 1. The generating unit 1440 includes a calculation unit 1441, a classification unit 1442, a priority specification unit 1443, and a change timing specification unit 1444.

The calculation unit 1441 has a function of outputting, to the priority specification unit 1443 and the change timing specification unit 1444, the basic processing time obtained for each task by multiplying the average processing time and the frame rate in accordance with the processing time information acquired from the processing time information acquisition unit 1430. In other words, the calculation unit 1441 performs the processing of the step S1002 in FIG. 10.

The classification unit 1442 has a function of classifying the tasks into a plurality of groups according to different levels of frequency of event occurrence based on the event occurrence frequency information acquired by the event occurrence frequency information acquisition unit 1410. The classification unit 1442 also transmits, to the priority specification unit 1443, information indicating the groups resulting from the classification and indicating tasks belonging to the respective groups. In other words, the calculation unit 1442 performs the processing of the step S1001 in FIG. 10.

The priority specification unit 1443 has a function of specifying the task priorities of the tasks, in accordance with the information indicating the groups resulting from the classification of the classification unit 1442 and indicating the tasks belonging to the respective groups, the basic processing time of each task calculated by the calculation unit 1441, and the specific priority information acquired by the task specific information acquisition unit 1420. In other words, the priority specification unit 1443 performs the processing of the steps S1003 through S1008, and the step S1010 in FIG. 10.

The change timing specification unit 1444 has a function of specifying a next timing for changing the priorities of the tasks in accordance with the time quantum values of the tasks and the basic processing time of the tasks calculated by the calculation unit 1441, the time quantum values calculated in the process performed by the priority specification unit 1443 to specify the priorities of the tasks. In other words, the calculation unit 1444 performs the processing of the step S1009 in FIG. 10.

The generating unit 1440 causes the calculation unit 1441, the classification unit 1442, the priority specification unit 1443, and the change timing specification unit 1444 to collaborate to perform the operations shown in the flowchart of FIG. 10. By doing so, the generating unit 1440 generates such priority information that indicates the task priorities in association with the respective states and the respective operation contents, in accordance with the flowchart of FIG. 9.

The output unit 1450 has a function of outputting, to the information processing device, the priority information generated by the generating unit 1440. Although the output unit 1450 may directly output the priority information to the information processing device, other output methods are possible. For example. the output unit 1450 may converts the generated priority information into a visible indication to a user for display on a monitor or the like. In this case, an operator may manually enter the priorities into the information processing device while looking at the indication.

Note that the priority information generating unit 104 described in the above Embodiment may of course has the structure equivalent to that of the priority information generating device 1400 shown in FIG. 14. In this case, the acquisition units acquire the respective information from the priority update control unit 106, and the output unit 1450 outputs the priority information to the priority information storage unit 103.

By making the priority information device external to the information processing device, a need for providing the information processing device with the structure of the priority information generating device is omitted. As a result, a size and manufacturing costs of the information processing device are reduced. Furthermore, although in the above Embodiment the priority information generating unit 104 generates the priority information specific to the information processing device 1, the priority information generating device 1400 is capable of generating the priority information that can be commonly used in various types of information processing devices.

(5) In the above Embodiment, the priority information specifies the priorities of the content tasks in association with the multitask application's states, and further in association with the operation contents available in the states. However, if there is no need for such a severe priority control, the priority information does not necessarily need to be associated with the states. In a case where the priority information unassociated with the states is generated, a total length of time required for calculating all the priorities is reduced compared with the case of the priority information associated with the states. On top of that, such priority information provides another advantageous effect that a length of time required for retrieving the priority information necessary for the priority control is reduced (since a smaller amount of information is generated as the priority information compared with the case of the priority information associated with the states, it takes less time to retrieve the information).

(6) In the above Embodiment, as shown in FIGS. 5 and 6, the event occurrence frequency information is stored separately from the processing time information. However, these two sets of the information may be associated with each other as a single set of information, because in both, a state, an operation content, and a task name are described in association with each other.

(7) Although in the above Embodiment the application including the map content and the picture content is described as an exemplary multitask application, the multitask application is not limited to this specific example. The multitask application may be any application for running a plurality of different tasks, and the tasks are not limited to the picture content task and the map content task. Examples of other tasks include a movie content task for rendering moving images such as a movie stored in the memory etc. of the information processing device, and a game application.

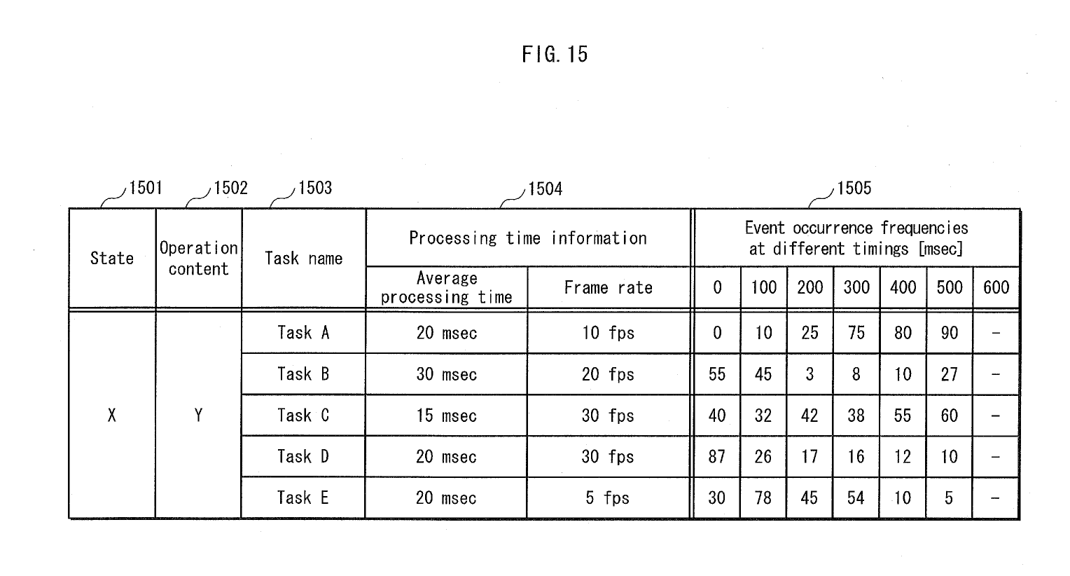

Furthermore, although the above Embodiment illustrates the example in which the multitask application runs two tasks, the multitask application may include three or more tasks. A specific example of a method for generating the priority information with the case of three or more tasks is described with reference to FIG. 15.

As shown in FIG. 15, assume that tasks A to E are associated with a state X and with an operation Y, and these tasks A to E have the event occurrence frequencies shown in FIG. 15. Note that in the figure the processing performance information with respect to each task is also described. As shown in FIG. 15, the source information may have a data structure in which the event occurrence frequency information is combined with the processing performance information, in other words, a data structure in which a state 1501, an operation content 1502, a task name 1503, a processing time 1504, and an event occurrence frequency 1505 are associated with each other.

Also assume that the priorities are specified from time t=0. Furthermore, the default value a₀ of the validity period a is 100 msec. In this case, the basic processing times of the tasks A to E are 20, 60, 45, 60, and 10 in the stated order from the (Equation 2).

Furthermore, based on the event occurrence frequencies at the time t=0, the tasks are classified into the group 1 with the low event occurrence frequency (which corresponds to event occurrence frequencies ranging from 0 to 33), the group 2 with the medium event occurrence frequency (which corresponds to event occurrence frequencies ranging from 34 to 66), and the group 3 with the high event occurrence frequency (which corresponds to event occurrence frequencies ranging from 67 to 100).

At the t=0, the tasks A and E are classified into the group 1, and the tasks B and C are classified into the group 2, and the task D is classified into the group 3.

Then, firstly, the time quantum values of the tasks A and E, which belong to the group 1, are acquired. Since, at this point of time, the group 1 is a group with the lowest event occurrence frequency, the value of SUM is 0. Accordingly, the time quantum values of the task A and the task E are 20 msec and 30 msec, respectively. Consequently, the value 30, which is largest among the time quantum values of the tasks A and E, is set as SUM in the group 1.

Subsequently, the time quantum values of the tasks belonging to the group 2 are acquired. Regarding the tasks B and C belonging to the group 2, the respective basic processing times are 60 and 45. By adding the SUM value 30, the time quantum values assigned to the task B and the task C are 90 and 75, respectively. Consequently, the value 90 of the task B, which is largest among the time quantum values of the tasks B and C, is set as SUM in the group 2.

Finally, the time quantum value of the task D belonging to the group 3 are acquired. The basic processing time of the task D is 10, and SUM to be added at this point of time is 90. Consequently, the time quantum value of the task D is set to be 100.

From the time quantum values calculated as above, the priorities of the tasks A to E at the time t=0 are 16, 2, 5, 0, and 14 in the stated order. Furthermore, given that PTₘₐₓ is 100, PTSₘₐₓ is 60, a₀=100, and β=0.5, the validity period a of the priorities is (85/60)×100×0.5=83.333 . . . from the (Equation 3). This validity period a is rounded up to a value evenly divided by the interval of the event occurrence frequency information, the validity period a is 100 msec. Accordingly, a next timing for changing the priorities is set to be time t=100.

Similarly, the tasks are classified into groups at the time t=100.

According to the event occurrence frequency information shown in FIG. 15, at the time t=100, the tasks A, C, and D belong to the group 1, the task B belongs to the group 2, and the task E belongs to the group 3.

The time quantum values of the tasks belonging to the group 1 are acquired; the time quantum values 20, 45, and 60 are set for the task A, the task C, and the task D, respectively. Consequently, the time quantum value 60, which is largest among the time quantum values, is set as SUM in the group 1.

Subsequently, by adding the SUM value 60 to the basic processing time of the task B, the time quantum value of the task B belonging to the group 2 is set to be 120. Since only the task B belongs to the group 2, the time quantum value 120 is set.

Subsequently, by adding the SUM value 120 to the basic processing time of the task E, the time quantum value of the task E belonging to the group 3 is set to be 130.

From the specific priority information of FIG. 3, the priorities of the tasks A to E at the time t=100 are 16, −1, 11, 8, and −1 in the stated order. Furthermore, given that PTₘₐₓ, is 130, PTSₘₐₓ, is 60, a₀=100, and β=0.5, the validity period a of the priorities is (115/60)×100×0.5=108.333 . . . . This validity period a is rounded up, so that a=200. Accordingly, a next timing for changing the priorities is set to be time t=300 (which corresponds to 100, which is a current value of t, +200, which is a calculated value of a). Meanwhile, assume a case where a threshold value above which the normalization processing is needed is set to be 100. In this case, since the time quantum values of the tasks B and E both exceed the threshold value 100, the time quantum values of the tasks are eventually divided by a constant value (e.g. 2), and the priorities of the tasks are specified based on time quantum values after division.

The above calculation processes are repeated until there is no event occurrence frequency remaining in the event occurrence frequency information (until the time t exceeds 600 msec in the example of FIG. 15). By doing so, such priority information is generated that indicates timing for changing the priorities of the tasks in response to the operation Y in the state X and indicating priorities to be set at the timings.

(8) Although in the above Embodiment the source information is held by the priority update control unit 106 and stored in the source information storage unit 102, the source information may be stored in the source information storage unit 102 from the beginning. The source information may also be held by the compound map-picture content 132. In this case, when the priority information is generated, the priority update control unit 106 acquires the source information from the multitask application control unit 131, and stores the acquired source information in the source information storage unit 102. Alternatively, the information processing device 1 may be provided with a communication function. In this case, using the communication function, the information processing device 1 acquires, from a server etc. external to the information processing device 1, the source information with respect to the multitask application to be run in the information processing device 1.

(9) Although the above Embodiment illustrates the example in which the input unit 12 is embodied as a touch pad and receives a user input made on the touch pad, the input unit 12 is not limited to the touch pad. The input unit 12 may be any other entity that is capable of receiving a user input. For example, the input unit 12 may be hard keys assigned with various functions that the information processing device 1 has, or a receiver that receives an instruction signal from a remote control sending an input signal to the information processing device 1.

(10) In the step S1008 of FIG. 10 in the above Embodiment, the time quantum values are divided by a constant value. However, a similar result is obtained by multiplying the time quantum values by a value that is greater than 0 and less than 1, and the priority information generating unit 104 may adopt this structure to generate the priority information.

(11) In the above Embodiment, the priority information indicates association with the operation contents available for a user. However, the operation contents are not limited to user operations, and may be any other events that can occur in the multitask application. For example, the operation contents may be executions of predetermined specific instructions (e.g. an instruction for rendering a particular image). In this case, the event occurrence frequency information indicates, on a task-by-task basis, changes in frequency of event occurrence from when the specific instructions have occurred.

(12) The above Embodiment illustrates the priority information generating unit 104 is configured to specify the priorities of the tasks by referring to the specific priority information and setting priorities corresponding to the time quantum values of the tasks calculated at times t as the priorities of the tasks. However, the priority information generating unit 104 may set the calculated time quantum values themselves as the priorities of the tasks.

With the above structure, there is no need for referring to the specific priority information and converting the calculated time quantum values to the priorities. As a result, processing loads of the priority information generating unit 104 are reduced.

(13) Each functional part of the block diagrams (see FIGS. 1 and 14, for example) in the above Embodiment may be implemented in the form of one or more LSIs (Large Scale Integrations), and a plurality of the functional parts may be implemented in the form of an LSI.

The LSI is also called an IC (Integrated Circuit), a system LSI, a super VLSI (Very Large Scale Integration), or an SLSI (Super Large Scale Integration) depending on the degree of integration.

Furthermore, if integration technology is developed that replaces LSIs due to the progress in semiconductor technology and other derivative technologies, integration of functional blocks using this technology is naturally possible. For example, the application of biotechnology is a possibility.

(14) It is also possible to have the following control program stored in a storage medium, or circulated and distributed through various communication channels: the control program comprising program codes for causing the processors in the small-sized information terminals or the circuits which are connected thereto to execute the operations of generating the priority information and the processing of controlling the priorities of the tasks based on the generated priority information (see FIGS. 7 to 12) as described in the above embodiments. Such a storage medium includes an IC card, a hard disk, an optical disk, a flexible disk, and a ROM. The circulated and distributed control program becomes available as it is contained in a memory and the like which can be read by a processor. The control program is then executed by the processor, so that the various functions as described in the Embodiment will be realized.

### <Supplementary Description 2>

Now, a description is given of preferred embodiments of the priority information generating device and the information processing device according to the present invention, and advantageous effects of the embodiments.

One aspect of the present invention provides a priority information generating device for generating priority information regarding priorities of a plurality of tasks included in a multitask application to be run by an information processing device, the priority information generating device comprising: an event occurrence frequency information acquisition unit acquiring event occurrence frequency information that indicates an event occurrence tendency in association with an operation available for a user of the information processing device, the event occurrence tendency indicating, on a task-by-task basis, changes in frequency of event occurrence over time from when the operation has been received in the information processing device; a processing time information acquisition unit acquiring processing time information indicating respective times required for processing the tasks to be run in the information processing device; and a generating unit generating the priority information in accordance with the event occurrence frequency information and the processing time information, the generated priority information indicating timings for changing the priorities of the tasks in response to the operation and indicating priorities to be set at the timings.

With the above structure, such priority information is generated that indicates the timings for changing the priorities in response to the operation that has been received from the user, in accordance with the changes in frequency of event occurrence over time from when the operation has been occurred with respect to each task. According to the above priority information, it is possible to appropriately change the priorities of the tasks and specify the priorities to be set.

Furthermore, in the above priority information generating device, the priority information may further indicate, in association with the operation, a multitask application's running state in which the operation is available.

With the above structure, the priority information generating device is able to generate precise priority information appropriate for the multitask application's running state. According to the above priority information, it is possible to appropriately change the priorities and specify the priorities to be set in accordance with the changes in frequency of event occurrence over time with respect to each task.

Moreover, in the above priority information generating device, the processing time information may include, with respect to each task, a basic processing time, which is a length of time required for processing the task, and a frame rate at which the task is processed in the information processing device, and the generating unit specifies the priorities to be set, based on a product of the basic processing time and the frame rate with respect to each task.

With the above structure, based on the respective times required for processing the tasks and the respective frame rates at which the tasks are processed, the timings for changing the priorities are appropriately specified from one timing to another.

Moreover, in the above priority information generating device, the generating unit may include: a calculation unit calculating, for each task, a first time quantum value obtained as the product of the basic processing time and the frame rate; a classification unit classifying the tasks into N groups at one of the timings for changing the priorities, N being 2 or greater, according to different levels of frequency of event occurrence at the one of the timings for changing the priorities; a priority specification unit specifying a priority to be set for one of the tasks based on a third time quantum value, the third time quantum value obtained by adding a second time quantum value to the first time quantum value of the one of the tasks, the second time quantum value being a largest time quantum value among the first time quantum values of tasks belonging to a group of a lower frequency than a group to which the one of the tasks belongs; and a change timing specification unit specifying another one of the timings following the one of the timings for changing the priorities based on the third time quantum values of the tasks.

With the above function of the priority specification unit, tasks with higher frequencies of event occurrence are assigned with higher priorities. On top of that, since the classification unit classifies the tasks into groups according to different levels of frequency of event occurrence and since the priority specification unit specifies the priorities to be set, calculation of the priorities of the tasks is simplified.

Moreover, in the above priority information generating device, when the third time quantum value of any one of the tasks exceeds a threshold, the priority specification unit may specify the priorities to be set, based on new time quantum values obtained by dividing the first time quantum values of the tasks by a predetermined value.

With the above structure, a situation is prevented in which an unnecessarily high priority is set to tasks belong to a group of a high event occurrence frequency because the tasks are added with time quantum value(s) set for other tasks belonging to group(s) with lower event occurrence frequency(cies).

Moreover, the above priority information generating device may further include a task specific information acquisition unit acquiring specific priority information that indicates time quantum values in one-to-one correspondence with the priorities of the tasks, wherein the priority specification unit refers to the specific priority information and specifies a priority corresponding to the third time quantum value as the priority to be set for the one of the tasks.

With the above structure, the priority specification unit is able to specify the priorities to be set for the tasks by converting the time quantum values calculated for the tasks into priorities.

Moreover, the above priority information generating device may further include an output unit outputting the priority information generated by the generating unit to an external device.

With the above structure, the external device is able to manage the priorities of the tasks in accordance with the priority information generated by the priority information generating device. On top of that, with the above structure, the external device itself does not need to have the function of generating the priority information.

Another aspect of the present invention provides an information processing device for running a multitask application including a plurality of tasks, comprising: a priority information storing unit for storing priority information generated by a priority information generating device according to any of claims 1 to 7; an input unit receiving an input operation from a user of the information processing device; and a priority update unit reading the priority information from the priority information storing unit, the priority information specified by a combination of the input operation and a multitask application's running state in which the input operation is available, and controlling the priorities of the tasks in accordance with timings for changing the priorities of the tasks based on the read priority information.

With the above structure, the priority control device is able to appropriately change the priorities and specify the priorities to be set in response to the input operation from the user, in accordance with the changes in frequency of event occurrence over time from when the operation has been received in the information processing device with respect to each task.

### INDUSTRIAL APPLICABILITY

A priority information generating device and a priority control device according to the present application is useful in, for example, a mobile information terminal that runs a multitask application including a plurality of tasks with one or a few CPUs.

### REFERENCE SIGNS LIST

1 information processing device
10 priority control device
11 task management unit
12 input unit
13 multitask application running management unit
14 buffer unit
15 combining unit
16 display
101 specific priority storage unit
102 source information storage unit
103 priority information storage unit
104 priority information generating unit (priority information generating device)
105 priority update unit
106 priority update control unit
111 task specific information storage unit
112 task priority storage unit
113 task priority update unit
114 task control unit
131 multitask application control unit
1321 map content
1322 map content
1400 priority information generating device
1410 event occurrence frequency information acquisition unit
1420 task specific information acquisition unit
1430 processing time information acquisition unit
1440 generating unit
1441 calculation unit
1442 classification unit
1443 priority specification unit
1444 change timing specification unit
1450 output unit
13211 map content task
13212 map content engine
13221 picture content task
13222 picture content engine

1-8. (canceled)

9. A priority information generating device for generating priority information regarding priorities of a plurality of tasks included in a multitask application to be run by an information processing device, the priority information generating device comprising:
an event occurrence frequency information acquisition unit acquiring event occurrence frequency information that indicates an event occurrence tendency in association with an operation available for a user of the information processing device, the event occurrence tendency indicating, on a task-by-task basis, changes in frequency of event occurrence over time from when the operation has been received in the information processing device;
a processing time information acquisition unit acquiring processing time information indicating respective times required for processing the tasks to be run in the information processing device; and
a generating unit generating the priority information in accordance with the event occurrence frequency information and the processing time information, the generated priority information indicating timings for changing the priorities of the tasks in response to the operation and indicating priorities to be set at the timings.

10. The priority information generating device of claim 9, wherein
the priority information further indicates, in association with the operation, a multitask application's running state in which the operation is available.

11. The priority information generating device of claim 9, wherein
the processing time information includes, with respect to each task, a basic processing time, which is a length of time required for processing the task, and a frame rate at which the task is processed in the information processing device, and
the generating unit specifies the priorities to be set, based on a product of the basic processing time and the frame rate with respect to each task.

12. The priority information generating device of claim 11, wherein
the generating unit includes:
a calculation unit calculating, for each task, a first time quantum value obtained as the product of the basic processing time and the frame rate;
a classification unit classifying the tasks into N groups at one of the timings for changing the priorities, N being 2 or greater, according to different levels of frequency of event occurrence at the one of the timings for changing the priorities;
a priority specification unit specifying a priority to be set for one of the tasks based on a third time quantum value, the third time quantum value obtained by adding a second time quantum value to the first time quantum value of the one of the tasks, the second time quantum value being a largest time quantum value among the first time quantum values of tasks belonging to a group of a lower frequency than a group to which the one of the tasks belongs; and
a change timing specification unit specifying another one of the timings following the one of the timings for changing the priorities based on the third time quantum values of the tasks.

13. The priority information generating device of claim 12, wherein
when the third time quantum value of any one of the tasks exceeds a threshold, the priority specification unit specifies the priorities to be set, based on new time quantum values obtained by dividing the first time quantum values of the tasks by a predetermined value.

14. The priority information generating device of claim 12, further comprising:
a task specific information acquisition unit acquiring specific priority information that indicates time quantum values in one-to-one correspondence with the priorities of the tasks, wherein
the priority specification unit refers to the specific priority information and specifies a priority corresponding to the third time quantum value as the priority to be set for the one of the tasks.

15. The priority information generating device of claim 9, further comprising:
an output unit outputting the priority information generated by the generating unit to an external device.

16. An information processing device for running a multitask application including a plurality of tasks, comprising:
a priority information storing unit for storing priority information generated by a priority information generating device according to claim 9;
an input unit receiving an input operation from a user of the information processing device; and
a priority update unit reading the priority information from the priority information storing unit, the priority information specified by a combination of the input operation and a multitask application's running state in which the input operation is available, and controlling the priorities of the tasks in accordance with timings for changing the priorities of the tasks based on the read priority information.
